(19) United States
(12) Patent Application Publication
(10) Pub. No.: US 2014/0309857 A1
(43) Pub. Date: Oct. 16, 2014

(54) ACTIVE CONTROL METHOD OF PEDAL EFFORT FOR ACCELERATOR

(71) Applicants: Kia Motors Corporation, Seoul (KR); Hyundai Motor Company, Seoul (KR)

(72) Inventors: Jeong Seon MIN, Gwangju (KR); Jeong Seop LEE, Yongin-si (KR)

(73) Assignees: Kia Motors Corporation; Hyundai Motor Company

(21) Appl. No.: 13/937,112

(22) Filed: Jul. 8, 2013

(30) Foreign Application Priority Data
Apr. 10, 2013 (KR) 10-2013-0039039

(51) Int. Cl. G05G 1/44

(52) U.S. Cl. CPC G05G 1/44
USPC 701/36

(57) ABSTRACT

An active control method of varying a pedal effort for an accelerator through which a current pedal effort for an accelerator can be varied actively. Pedal effort is set per an operated memory switch when a driver operates the memory switch in a state that a vehicle provided with an accelerator, a pedal effort of which is controllable, and having an electrically powered memory seat, starts-on.

### CROSS-REFERENCE TO RELATED APPLICATION

This application claims under 35 U.S.C. §119(a) the benefit of priority to Korean Patent Application No. 10-2013-0039039 filed on Apr. 10, 2013, the entire contents of which are incorporated herein by reference.

### TECHNICAL FIELD

The present disclosure relates to an active control method of pedal effort for an accelerator, and more particularly, to an active control method of pedal effort for an accelerator capable of actively varying the current pedal effort for the accelerator to a pedal effort set per a memory switch when the memory switch is operated in a vehicle provided with an accelerator having a pedal effort control module and an electrically powered memory seat.

### BACKGROUND

An organ style accelerator for a vehicle is shown in FIG. 1 as an example of an accelerator for a vehicle wherein the accelerator according to the related art includes a pedal arm housing 1 fixed to a vehicle body panel under a driver's seat, a pedal arm 2 with one end rotatably connected to the pedal arm housing 1, a pedal bracket 3 fixed to a floor panel under the driver's seat, and a pedal pad 4 with one end rotatably hinged to the pedal bracket 3 and the other end ball-jointed to the pedal arm 2.

A spring plate 5 is connected to one end of the pedal arm 2, which is disposed within the pedal arm housing 1, wherein one end of a spring 6 is supported by the spring plate 5 and the other end thereof is supported by the pedal arm housing 1.

In the accelerator according to the related art pedal effort is transmitted to the pedal pad 4 such that the spring 6 is compressed when the pedal arm 2 rotates via a hinge shaft 7 with respect to the pedal arm housing 1.

However, according to the accelerator of the related art, since the spring 6 has an elastic coefficient set in advance to meet safe regulations prescribed by each nation, which has to be used therein, controlling the pedal effort without replacing the spring 6 with a new one is impractical, and there is no method of actively controlling the pedal effort for the accelerator in accordance with a location of the driver's seat.

The description provided above as the related art is just to help understanding the background of the present disclosure and should not be construed as being included in the related art known by those skilled in the art.

### SUMMARY

The present disclosure has been made in an effort to solve the above-described problems associated with the prior art, and the object of the present disclosure is to provide an active control method of a pedal effort for an accelerator, including: determining whether a signal for operating a memory switch is generated when a vehicle provided with an accelerator, where a pedal effort is controllable, and an electrically powered memory seat starts-on; and controlling the pedal effort by varying the current pedal effort to a target pedal effort set per operated memory switch number, when the memory switch has been operated in a memory switch operation determining step.

The active control method of controlling pedal effort for an accelerator further includes, determining whether a pedal effort control system is in a normal state or not when the vehicle starts-on before the memory switch operation determining step is called out.

The method further includes, determining whether a pedal effort control is in a possible state or not in accordance with the vehicle's driving status, when the pedal effort control system is determined to be in the normal state in a pedal effort control system determining step.

The current pedal effort is kept as an existing pedal effort (previous pedal effort) state, when the memory switch has been determined as not being operated in the memory switch operation determining step.

The pedal effort control possibility determining step is performed only when the pedal control system is determined to be in the normal state. The current pedal effort for the accelerator is reset as an initial pedal effort when the pedal effort control system is determined to be in an abnormal state in the pedal effort control system determining step.

Only when all conditions are satisfied, such that a voltage signal of a battery is normal, there is no signal for initiating the system pursuant to an urgent situation. The signal for a pedal effort active control mode is generated when the pedal effort control system is determined to be in the normal state in the pedal effort control determining step.

A pedal effort control possible mode only is determined in a state that a vehicle is not driving currently; a pedal effort control impossible mode is determined in a state that the vehicle is driving currently in the pedal effort control possibility determining step.

The current pedal effort for the accelerator is controlled to a lower set pedal effort, an average set pedal effort, or a higher set pedal effort in accordance with the target pedal effort set per memory switch number in a pedal effort control step.

### BRIEF DESCRIPTION OF THE DRAWINGS

The above and other features of the present disclosure will now be described in detail with reference to certain exemplary embodiments thereof illustrated the accompanying drawings which are given herein below by way of illustration only, and thus are not limitative of the present disclosure, wherein:

FIG. 1 is a perspective view illustrating an accelerator not having a pedal effort control function according to the related art;

FIGS. 2 through 5 are views illustrating an accelerator having a pedal effort control function according to an embodiment of the present disclosure, respectively; and

FIG. 6 is a flowchart illustrating a method of actively controlling the pedal effort for an accelerator having a pedal effort control function according to an embodiment of the present disclosure.

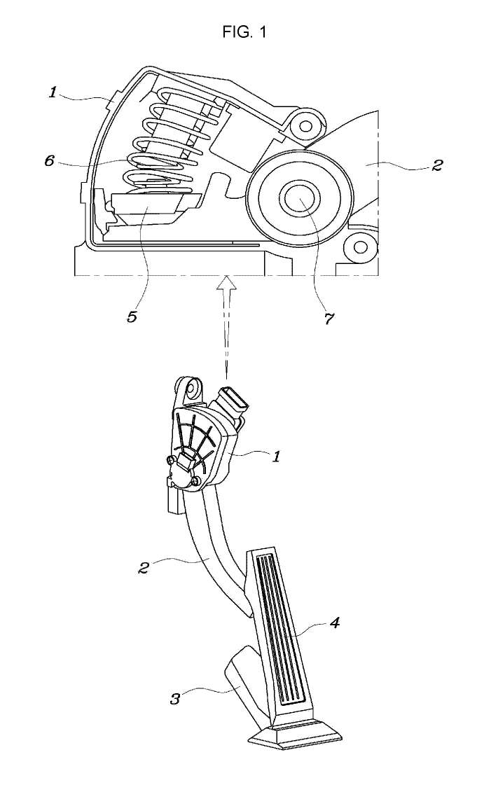

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

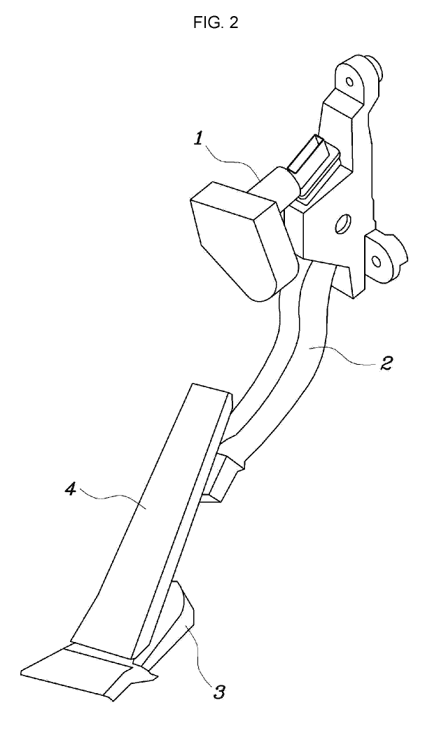

Referring to FIGS. 2 through 5, an accelerator for a vehicle having a pedal effort control function may include, a pedal arm housing 1 fixed to a vehicle body panel under a driver's seat, a pedal arm 2 with one end rotatably connected to the pedal arm housing 1, a pedal bracket 3 fixed to a floor panel under a driver's seat, and a pedal pad 4 with one end rotatably hinged to the pedal bracket 3 and the other end ball-jointed to the pedal arm 2.

Here, a spring plate 5 may be connected to one end of the pedal arm 2 which is disposed in the pedal arm housing 1, and the pedal arm 2 may be rotatably connected to the pedal arm housing 1 through a hinge shaft 7.

The accelerator, provides a pedal effort control module 10 including: a spring 11 with one end supported on an end of the pedal arm 2 disposed in the pedal arm housing 1; a spring fixing block 12 arranged to support the other end of the spring 11; a motor 13 fixed to the pedal arm housing 1; and a power transmitter 14 that transmits power from the motor 13 to the spring fixing block 12 and moves the spring fixing block 12 to vary a length of the spring 11.

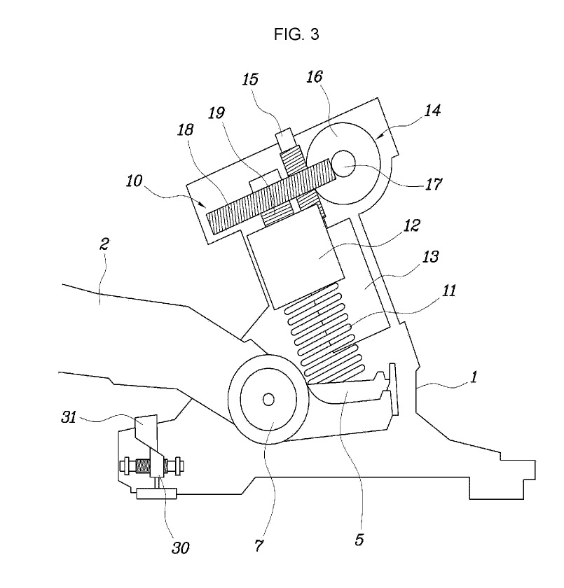

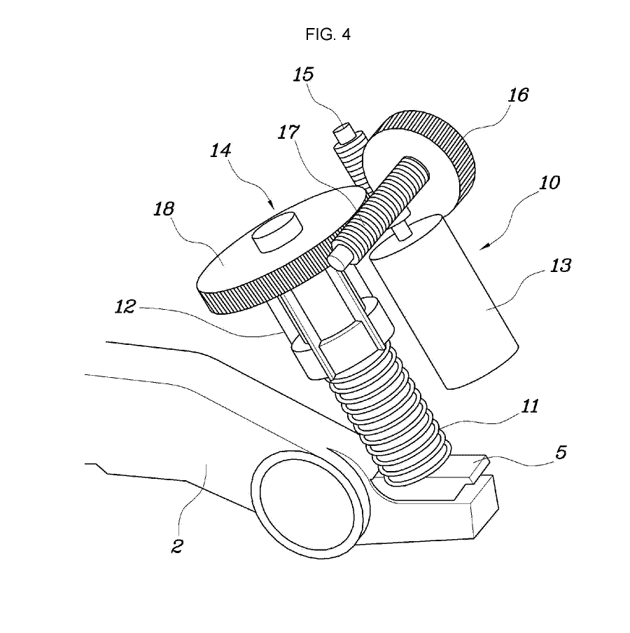

Referring to FIGS. 3 and 4, the spring 11 may be supported directly by one end of the pedal arm 2, or the lower part of the spring 11 may be supported by the spring plate 5 that is connected to one end of the pedal arm 2 disposed in the pedal arm housing 1.

Accordingly, when the pedal arm 2 rotates around the hinge shaft 7, the spring 11 is compressed and elastically deformed between the spring plate 5 and the spring fixing block 12, and at this time the pedal effort is transmitted to the pedal pad 4 through the pedal arm 2.

The power transmitter 14 is arranged to connect the motor 13 and the spring fixing block 12 for transmitting power from the motor 13 to the spring fixing block 12. The power transmitter 14 includes a first worm gear 15 integrally coupled to a shaft of the motor 13; a first worm wheel gear 16 meshed with the first worm gear 15; a second worm gear 17 integrally coupled to a center of the first worm wheel gear 16; a second worm wheel gear 18 meshed with the second worm gear 17; and a gear bolt 19 which integrally protrudes from a center of the second worm wheel gear 18 and on an outer peripheral surface of which a plurality of threads is processed.

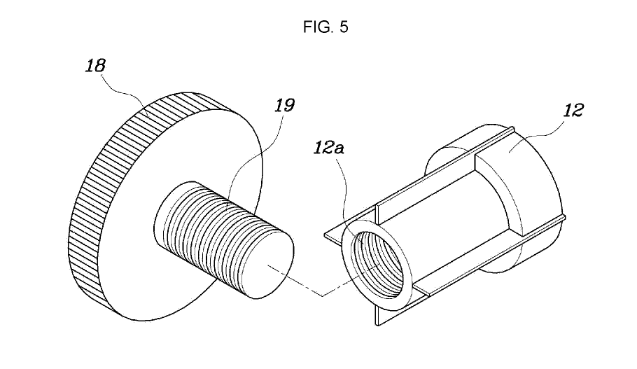

Furthermore, referring to FIG. 5, a plurality of screw-grooves 12a are processed on an inner peripheral surface of the spring fixing block 12 to be screw-fastened with the gear bolt 19 wherein when the second worm wheel gear 18 rotates, the spring fixing block 12 moves axially along the gear bolt 19 to vary a length of the spring 11 since the movement of the spring fixing block 12 varies pedal effort.

Meanwhile, operation of the motor 13 may be controlled automatically by a controller (not shown) in accordance with a driving condition, a driver's condition, etc.

Under the vehicle provided with the accelerator having the pedal effort control module 10 and the electrically powered memory seat, pedal effort of the accelerator can be varied actively by controlling the controller in a start-on state of the vehicle in accordance with an operation of a memory switch by a driver.

That is, when the driver operates the memory switch provided with the memory seat, the current pedal effort is controlled to actively vary a pedal effort set per the memory switch that is operated by the pedal effort control module 10.

Here, the electrically powered memory seat refers to a seat that moves forward/rearward in a vehicle by the motor when a driver operates a switch and has a function to memorize its location wherein when a driver operates the memory switch, the seat moves automatically to the memorized location per operated switch.

The electrically powered memory seat has been appreciated by a person who has ordinary skill in a field to which the invention pertains such as Korean Unexamined Patent Publication No. 20-1998-0066748, and the detailed description thereof is omitted.

An example of varying the pedal effort in accordance with an operation of the memory switch, when a driver operates a memory switch No. 1, a driver's electrically powered seat moves forward in the vehicle. The driver's seat moves forward in the vehicle in a case when the driver having a smaller and shorter frame than an average size level for that the driver feels pretty fatigued for operating an accelerator. Accordingly, at this time, the pedal effort is controlled to be a lower level of a set pedal effort thereby to reduce the fatigue caused by operating the accelerator and improve easiness of operating the accelerator.

As another example, when a driver operates a memory switch No. 2, the driver's electrically powered seat moves to a middle range along an entire length of a seat track. The driver's seat moves to the middle range when a driver has an average frame level so that the driver comfortably operates the accelerator with a usual force. Accordingly, at this time, the pedal effort is controlled to the average level thereby to improve the operation feeling of the accelerator.

For a final example, when a driver operates a memory switch No. 3, the driver's electrically powered seat moves rearward in the vehicle. The driver's seat moves rearward in the vehicle when a driver has a larger frame than the average level so that the driver can easily operates the accelerator with small force. This may cause a safety problem such as rapid starting. Accordingly, at this time, the pedal effort is controlled to be a higher level of a set pedal effort thereby to overcome the safety problem and improve the operation feeling of the accelerator.

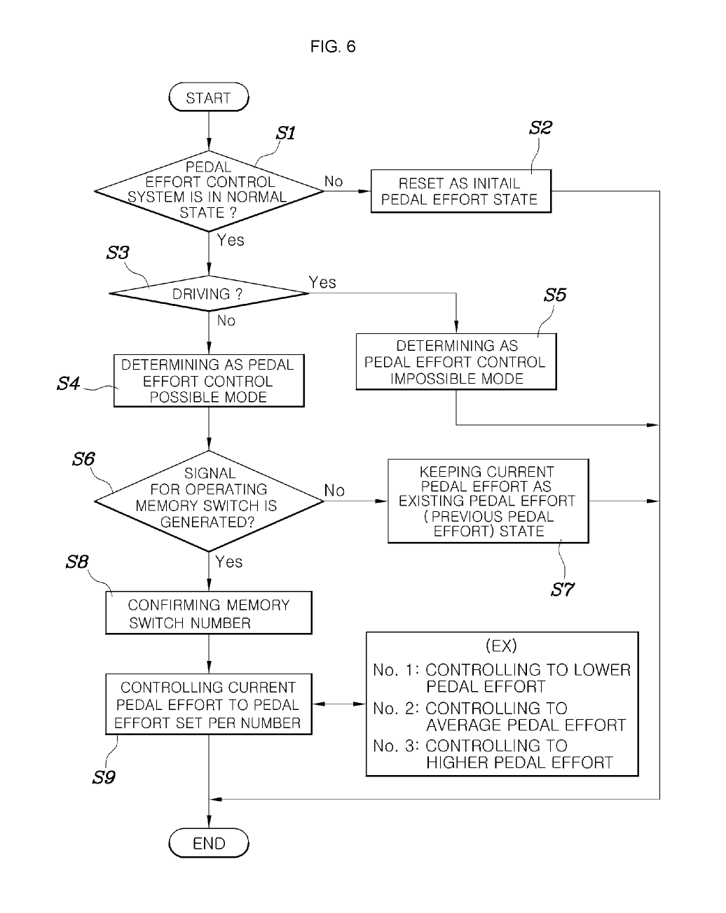

Referring to FIG. 6, an active control method of a pedal effort for an accelerator according to an embodiment of the present disclosure, may include: determining whether a pedal effort control system is in a normal state or not when a vehicle provided with an accelerator, where the pedal effort is controllable and an electrically powered memory seat, starts-on; determining whether the pedal effort is controllable or not in accordance with a vehicle driving status, when the pedal effort control system has been determined to be in the normal state in the pedal effort control system determining step; determining whether a signal for operating a memory switch is generated or not after the pedal effort control possibility determining step; and controlling the pedal effort by varying the current pedal effort to a target pedal effort set per memory switch number operated, when the memory switch has been determined to be operated in the memory switch operation determining step.

Here, only when the pedal effort control system is determined to be in the normal state in the pedal effort control system determining step, that is, when all conditions are satisfied such that a voltage signal of a battery is normal, there is no signal for initiating the system pursuant to an urgent situation, and when the signal for a pedal effort active control mode is generated, the pedal effort control possibility determining step is performed.

Meanwhile, when the pedal effort control system is determined to be in an abnormal state in the pedal effort control determining step, the current pedal effort for the accelerator is reset as an initial pedal effort state.

Here, the initial pedal effort state refers to a reset state of the pedal effort.

Further, in the pedal effort control possibility determining step, a pedal effort control possible mode only is determined in a state that the vehicle is not driving, and a pedal effort control impossible mode for safety is determined in a state that the vehicle is driving.

Meanwhile, in the memory switch operation determining step, when the memory switch is determined as not operating, the current pedal effort for the accelerator is kept as an existing pedal effort (previous pedal effort) state.

However, in the memory switch operation determining step, when the memory switch is determined as operating, the current pedal effort for the accelerator is controlled to be a lower level, an average level, or a higher level, which are set in accordance with the target pedal effort set per memory switch number.

For example, it is assumed that the memory switches are numbered as No. 1, No. 2 and No. 3. When switch No. 1 is operated, the electrically powered seat moves forward in the vehicle. When switch No. 2 is operated, the electrically powered seat moves to the middle range along an entire length of a seat track, and when switch No. 3 is operated, the electrically powered seat moves rearward in the vehicle.

A driver who has a smaller frame than an average level generally may move the driving seat forward in the vehicle for more comfortable feeling of driving, and in this case the driver operates memory switch No. 1. The driver who has a smaller frame than the average level may feel much fatigued when operating the accelerator. Accordingly, at this time the pedal effort is controlled to be the lower level of the set pedal effort and thus the fatigue caused from the operation of the accelerator can be reduced greatly and the operation feeling of the accelerator by the driver can be improved.

Secondly, a driver who has an average frame level generally may move his/her driving seat to the middle range along the entire length of the seat track, and in this case the driver operates memory switch No. 2. The driver who has the average frame level may comfortably operate the accelerator with a usual force and the pedal effort is controlled to be the average level thereby to improve the operation feeling of the accelerator by the driver.

Finally, a driver who has a larger frame than the average level generally may move his/her driving seat rearward in the vehicle, and in this case the driver operates memory switch No. 3. The driver with the larger frame than the average level may easily operate the accelerator with a smaller force and thus it may cause a safety problem such as rapid starting. Accordingly, at this time the pedal effort is controlled to be a higher level of a set pedal effort thereby to overcome the safety problem and improve the operation feeling of the accelerator by the driver.

Hereinafter, the operations of the present embodiment according to the present disclosure will be described, and firstly a control of the pedal effort for the accelerator will be described.

Referring to FIG. 3, the motor 13 is operated by a controller, and power from the motor 13 is transmitted to the spring fixing block 12 through the worm gears 15 and 17, the worm wheel gears 16 and 18, and the gear bolt 19, and the spring fixing block 12 moves upward or downward along the gear bolt 19.

When the spring fixing block 12 moves upward along the gear bolt 19 (to a receding direction from the spring plate), the spring 11 is lengthened through its elastic recovery, and the pedal effort for an accelerator decreases due to a decrease of spring force applied to the pedal arm 2.

On the contrary, when the spring fixing block 12 moves downward along the gear bolt 19 (approaching toward the spring plate), the spring 11 is shortened by being compressed, and the pedal effort for the accelerator increases due to an increase of spring force applied to the pedal arm 2.

The motor 13 is configured to automatically operate with a controller (not shown) wherein, for an example, when a driver operates memory switch No. 1, the driver' seat moves forward in the vehicle and at this time the current pedal effort for the accelerator is controlled to be the lower level. Further, when the driver operates memory switch No. 2, the driver' seat moves to the middle range of the entire length of the seat track and at this time the current pedal effort is controlled to be the average level. When the driver operates memory switch No. 3, the driver' seat moves rearward at the vehicle and at this time the current pedal effort for the accelerator is controlled to be the higher level, and thereby more improved acceleration performance can be ensured and the fatigue caused from the operation of the accelerator can be reduced greatly.

Further, pedal effort is controlled to be the lower level in a low speed driving (downtown driving) thereby to reduce fatigue caused from operating the accelerator, and the pedal effort is controlled to be the higher level in a high speed driving (expressway driving) thereby to reduce an ankle fatigue of a driver by supporting the pedal constantly.

Furthermore, the pedal effort is decreased to increase a pedal operation amount on an uphill road and the pedal effort is increased to decrease the pedal operation amount on a downhill road.

In addition, the pedal effort is increased to ensure safety during over speed driving or by a safety mode, and further the pedal effort may be controlled properly, considering an age, sex or condition of a driver.

Referring to FIG. 6, a method of actively controlling a pedal effort for an accelerator in accordance with the operation of the memory switch by a driver in a vehicle provided with a pedal effort control module and an electrically powered memory seat will be described.

When a vehicle starts-on, a controller determines whether a pedal effort control system is in a normal state or not (step S1) wherein the pedal effort control system is determined as in the normal state, when all conditions are satisfied such that a voltage signal of a battery is in the normal state, there is no signal for initiating the system pursuant to an urgent situation, and the signal for a pedal effort active control mode is generated.

Here, the pedal effort control system is determined as being in an abnormal state, when the voltage signal of the battery is less than 9V or more than 16.5V.

If the pedal effort control system is determined as being in the abnormal state, the current pedal effort for the accelerator is reset as an initial pedal effort state (step S2).

When the pedal effort control system is determined as being in the normal state, the controller determines whether the vehicle is driving or not (step S3), and at this time the controller determines a pedal effort control possible mode only in a state that the vehicle is not driving (step S4), and on the contrary the controller determines a pedal effort control impossible mode for safety in a state that the vehicle is driving and forcibly ends a pedal effort control logic (step S5).

Furthermore, the controller determines whether the signal for operating the memory switch has been generated from the electrically powered memory seat after determining it as a pedal effort possible mode (step S6).

Here, the controller performs a logic for varying the current pedal effort for an accelerator to a target pedal effort set per operated memory switch number, when the signal for operating the memory switch by a driver has been generated, and on the contrary the controller keeps the current pedal effort as the existing pedal effort (previous pedal effort) state when the signal for operating the memory switch has not been generated (step S7).

Meanwhile, when the controller performs the logic that the signal for operating the memory switch is generated and as a result the pedal effort for the accelerator is varied to the set target pedal effort, the controller determines which number of the operated memory switch is (step S8) and then allows the current pedal effort for the accelerator to be varied mainly into 3 kinds of pedal efforts in accordance with the number of the operated memory switch (step S9).

Firstly, in a case where a driver operates memory switch No. 1, the driver's seat moves forward in the vehicle, and at this time, the current pedal effort is controlled to be the lower level thereby to greatly reduce the fatigue caused from operating the accelerator and to improve the operation feeling of the accelerator.

Secondly, in a case where a driver operates memory switch No. 2, the driver's seat moves to a middle range of an entire length of a seat track and at this time the pedal effort for the accelerator is controlled to be an average level thereby to improve the operation feeling of the accelerator.

Thirdly, in a case where a driver operates memory switch No. 3, the driver's seat moves rearward in the vehicle, and at this time, the pedal effort for the accelerator is controlled to be a higher level thereby to overcome the safety problem such as rapid starting and improve the operation feeling of the accelerator.

Meanwhile, the controller stores the pedal effort corresponding to memory switch number that has been operated finally, when there is a record of controlling the pedal effort by the driver using the memory switch, and after this, if necessary, the current pedal effort is varied to the stored final pedal effort while keeping the current pedal effort as the existing pedal effort (previous pedal effort).

Even though the pedal effort for an accelerator is varied mainly into three kinds of pedal efforts in accordance with the number of the memory switch in the present embodiment, but it is not limited thereto, and it may be varied into more than three kinds of pedal efforts.

When the pedal effort for an accelerator is controlled to the set pedal effort in accordance with the operation of the memory switch in a state that the vehicle, including the accelerator provided with a pedal effort control module and the electrically powered memory seat, starts-on, all drivers can ensure improved strokes for an accelerator thereby to ensure improved acceleration performance, and especially to greatly reduce fatigue caused from operating the accelerator.

As described above, under the accelerator according to an embodiment of the present disclosure, a length of the spring 11 can be varied by the movement of the spring fixing block 12 through the operation of the motor 13 without replacing separately components thereby to vary easily the pedal effort for satisfying fully the safety regulations with respect to the pedal effort for an accelerator regardless of kinds of vehicle.

Further, the fatigue caused from the operation of an accelerator can be reduced greatly by varying actively the pedal effort for an accelerator in accordance with the operation of the memory switch.

The present disclosure has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An active control method of a pedal effort for an accelerator, comprising:
(i) determining whether a signal for operating a memory switch is generated when a vehicle starts on, the vehicle having an accelerator, the pedal effort of which is controllable, and an electrically powered memory seat; and
(ii) controlling the pedal effort by varying pedal effort to a target pedal effort set per a particular operated memory switch, when the memory switch has been determined to be operated in the determining step (i).

2. The active control method of claim 1, further comprising;
(iii) determining whether a pedal effort control system is in a normal state or not when the vehicle starts-on before the memory switch operation determining step (i).

3. The active control method of claim 2, further comprising;
determining whether the pedal effort control is in a possible state or not in accordance with the vehicle's driving status, when the pedal effort control system is determined to be in the normal state in the determining step (iii).

4. The active control method of claim 1,
wherein the current pedal effort is kept as a current pedal effort (state, when the memory switch has not been operated in the memory switch operation determining step.

5. The active control method of claim 3, wherein the pedal effort control possibility determining step is performed only when a pedal control system is determined to be in the normal state, and the current pedal effort for the accelerator is reset as an initial pedal effort when the pedal effort control system is determined to be in an abnormal state in the pedal effort control system determining step.

6. The active control method of claim 2, wherein only when all conditions are satisfied such that a voltage signal of a battery is normal, there is no signal for initiating the system pursuant to an urgent situation, and the signal for a pedal effort active control mode is generated, the pedal effort control system is determined to be in the normal state in the pedal effort control system determining step.

7. The active control method of claim 3, wherein a pedal effort control possible mode only is determined in a state that the vehicle is not driving currently, and a pedal effort control impossible mode is determined in a state that the vehicle is driving currently in a pedal effort control possibility determining step.

8. The active control method of claim 1, wherein the current pedal effort for an accelerator is controlled to a lower set pedal effort, an average set pedal effort, or a higher set pedal effort in accordance with the target pedal effort set per the particular operated memory switch in the pedal effort controlling step.
